(19) United States
(12) Patent Application Publication
(10) Pub. No.: US 2009/0164177 A1
(43) Pub. Date: Jun. 25, 2009

(54) TOLERANCE ANALYZING/CALCULATING SYSTEM, TOLERANCE ANALYZING METHOD, AND STORAGE MEDIUM

(75) Inventor: Kazuhiko HAMAZOE, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/333,429

(22) Filed: Dec. 12, 2008

(30) Foreign Application Priority Data
Dec. 14, 2007 (JP) 2007-322744

(51) Int. Cl. G06F 17/50

(52) U.S. Cl. 703/1

(57) ABSTRACT

A tolerance analyzing/calculating system analyzes and examines the size tolerance of each component configuring a structure with respect to a size tolerance at the time of assembly of the structure designed with design data. This system comprises a size condition setting unit for defining design data, and the size tolerance of each component, a first analysis executing unit for obtaining a variance or a deviation by making a primary analysis with the use of the size tolerance defined by the size tolerance setting unit, and an optimum minimum gap calculating unit for calculating an optimum minimum gap value by inversely calculating a gap value, which satisfies quality required for a design specification value, with the use of the variance or the deviation obtained by the primary analysis executing unit.

### BACKGROUND OF THE INVENTION

1. Field of the Invention

The present invention relates to a tolerance analyzing/calculating system for analyzing/examining each size tolerance of each component with respect to a size tolerance (design specification value) at the time of assembly of a structure designed with design data such as three-dimensional CAD (Computer Aided Design) data, two-dimensional drawing data, etc., which is utilized for a design, manufacturing, etc., and more particularly, to a technique for optimizing a minimum gap (GAP) with a tolerance analysis.

2. Description of the Related Art

A “sensitivity” and a “contribution ratio” which are used in this specification and what is claimed is, are initially described.

The “sensitivity” indicates the degree of influence that the size tolerance of each component exerts on a design specification value (measurement target) in terms of a structure regardless of a tolerance value. Namely, as the value of sensitivity increases, a size becomes more important to quality required for a design specification value.

In FIG. 1A, if a moves by 1 mm in a structure Z composed of components X and Y, also a GAP moves by 1 mm. This case is referred to as “sensitivity=1”.

Similarly, in FIG. 1B, if b moves by 1 mm, a GAP moves by 0.707 mm when θ=45 degrees because GAP=cos θ×b. Accordingly, the sensitivity=0.707 in this case.

The contribution ratio is a ratio of each size tolerance value when the total sum of size tolerances of components that configure a design specification value (measurement target) is assumed to be 100 percent. Namely, as the contribution ratio becomes higher, a tolerance value relatively increases.

In the meantime, a size tolerance indicates the degree of shift (allowable range) from a design reference value in actual manufacturing. Accordingly, the probability that a manufactured structure becomes defective increases if a tolerance is too large. In contrast, if the tolerance is too small, manufacturing operations with high precision become necessary, leading to an increase in cost.

Conventionally, when a size tolerance of a structure or each component is set in a design department, a size tolerance (design specification value) of each component at the time of device assembly is obtained with a manual calculation using, for example, the root sum square of the size tolerance of each component, or the size tolerance is empirically determined, for example, by diverting a size tolerance from a past drawing with similarity in almost all cases.

With such a conventional technique, a tolerance in consideration of a three-dimensional shape cannot be set, and a calculation error, etc. is apt to occur in a recent product design with high density. As a result, important sizes cannot be grasped completely.

This leads to the state where design specification values cannot be satisfied at the time of assembly of a structure. At the worst, the structure cannot be assembled, which requires the structure to be redesigned and again manufactured.

To overcome such problems, tolerance analyzing systems utilizing three-dimensional CAD data have been commercialized, and have started to be utilized at a design scene in recent years.

Additionally, the need to downsize/save space of a development device has become urgent in recent years, and also attempts to minimize a gap between components with a tolerance analyzing system have been made.

For example, the device disclosed by Patent Document 1 (Japanese Laid-open Patent Publication No. H8-166972) obtains an influence of a tolerance of a component exerted on a change in a behavior when the behavior of the component configuring a mechanism is analyzed.

FIG. 2 is a flowchart showing an example of procedures for analyzing/calculating a tolerance in a conventional tolerance analyzing/calculating system.

In the example shown in this figure, the tolerance analyzing/calculating system initially captures three-dimensional shape data from a three-dimensional CAD, etc. in step S1.

Next, in step S2, the system causes an operator to specify a tolerance analysis target. Then, in step S3, the system causes the operator to input a size tolerance value to be examined.

Then, in step S4, the system makes a tolerance analysis based on these items of information. Next, the system calculates quality (a value) corresponding to a design specification value, and also calculates a sensitivity, a contribution ratio, and a deviation (a) in step S5.

In step S6, the operator determines based on the values of the sensitivity and the contribution ratio whether or not the quality reaches a satisfactory level. If the operator determines that the quality reaches the satisfactory level (“OK” in step S6), the tolerance analysis is completed. Alternatively, if the operator determines that the quality does not reach the satisfactory level (“NG” in step S6), the operator causes the system to inversely calculate a minimum gap (GAP) value from the deviation value in step S7. Then, the system modifies the value of the size in the CAD data from the minimum gap value. Additionally, each size tolerance is again examined in consideration of the entire balance while referencing the sensitivity and the contribution ratio, and the design is again reviewed. Then, the process goes back to step S3, in which the value of the size tolerance obtained by the examination again made in step S7. Thereafter, the processes in steps S3 to S7 are repeated, and the tolerance analysis is completed.

If a conventional tolerance analyzing/calculating system is used, a size tolerance that satisfies desired quality is obtained by executing such processes.

Additionally, Patent Document 2 (International Publication Pamphlet No. WO07/20679) discloses the system as a system considering the problems of conventional tolerance analyzing/calculating systems.

The system disclosed by Patent Document 2 can calculate a size tolerance that can satisfy desired quality while reducing the labor of an operator at the time of calculation of each size tolerance.

However, it is not easy to make optimum tolerance settings/optimum minimum gap calculation even with a conventional tolerance analyzing/calculating system due to the following reasons.

(1) A conventional tolerance analyzing/calculating system examines a quality level (σ value) that guarantees a gap to be examined based on defined tolerance information when tolerances are accumulated, and requires an optimum minimum gap value, which satisfies required quality, to be manually and inversely calculated from analysis results.

(2) The minimum gap value obtained in (1) is implemented only by operator's determining the degree of adjustment of the size of a component of a structure. Additionally, a size tolerance must be examined by modifying and again analyzing CAD data for each examined size. As a result, the number of analyses increases.

(3) The size tolerance value of each component is adjusted if it is proved, from analysis results, to be difficult to implement the optimum minimum gap value satisfying the desired quality. At this time, however, it is necessary to again examine each size tolerance in consideration of the entire balance based on the sensitivity and the contribution ratio, which are obtained from the analysis results. This leads to an increase in the number of analyses.

(4) Restrictions such as a processing condition, etc. are imposed on an actual component, and a tolerance has its limit in almost all cases. Additionally, setting a tolerance with high precision without careful thought also increases component cost.

It is one of significant challenges in a product design to enable an optimum size tolerance to be efficiently set in consideration of the above described matters.

### SUMMARY OF THE INVENTION

An object of the present invention is to provide a tolerance analyzing/calculating system, a tolerance analyzing method, and program, which enables a tolerance design, a pre-examination of accumulation of tolerances, and an optimum tolerance assignment in a design department.

Another object of the present invention is to provide a tolerance analyzing/calculating system, a tolerance analyzing method and program, which can prevent an assembly error from occurring in a product assembly step.

A further object of the present invention is to provide a tolerance analyzing/calculating system that implements a space-saving design, and gap management in the design phase of a product.

The present invention assumes a tolerance analyzing/calculating system for analyzing and examining the size tolerance of each component configuring a structure with respect to a size tolerance at the time of assembly of the structure designed with design data, and comprises a size condition setting unit, a primary analysis executing unit, and an optimum minimum gap calculating unit.

The size condition setting unit defines design data, and the size tolerance of each component.

The primary analysis executing unit obtains a variance or a deviation by making a primary analysis with the use of the size tolerance defined by the size tolerance setting unit.

The optimum minimum gap calculating unit calculates an optimum minimum gap value by inversely calculating a gap value, which satisfies quality required for a design specification value, with the use of the variance or the deviation obtained by the primary analysis executing unit.

The tolerance analyzing/calculating system may further comprise a modified size assigning unit for calculating the size value of each component in order to implement the optimum minimum gap value obtained from the results of the primary analysis. In this system, the size condition setting unit defines whether a size is either unchangeable or changeable, and a ratio in the case of a changeable size as attribute value information of the each component, and the modified size assigning unit determines a size value to be controlled in order to implement the optimum minimum gap value based on the attribute information.

Additionally, the tolerance analyzing/calculating system may further comprise an allowable maximum gap value setting unit for setting an allowable maximum gap value that is a maximum gap allowable in design, and a modified size tolerance extracting unit for adjusting the size tolerance of each component if the optimum minimum gap value calculated by the optimum minimum gap calculating unit is larger than the allowable maximum gap value.

Furthermore, the tolerance analyzing/calculating system may further comprise a data obtaining unit for capturing attribute information including a material attribute or sheet plate information within the design data, a limit tolerance table that makes a correspondence between applicable limit tolerance information and a shape, a size, or a material, a first determining unit for determining the limit value of the size tolerance of each component by comparing the limit tolerance table and the shape, the size and the attribute information, which are read from the design data, and a modified size tolerance extracting unit for extracting a size tolerance value that is adjustable and has a high effect produced by an adjustment within the optimum minimum gap value based on the limit value of the size tolerance, and sensitivities and contribution ratios, which are obtained from the results of the primary analysis.

Still further, the tolerance analyzing/calculating system may further comprise a secondary analysis executing unit for making a secondary analysis for calculating an optimum minimum gap value when precision is increased to a limit in terms of tolerance from the limit value of the size tolerance determined by the first determining unit for the size tolerance value extracted by the modified size tolerance extracting unit.

Still further, the tolerance analyzing/calculating system may further comprise a second determining unit for obtaining the optimum size and the size tolerance of each component from the results of the primary analysis.

Still further, the tolerance analyzing/calculating system may be connected to a designing device holding the design data, link the size value and the size tolerance value of each component to the design data within the designing device, and feed the optimum size and size tolerance to the designing device, which reproduces the fed back information and reflects the reproduced information on shape data.

Still further, the tolerance analyzing/calculating system may further comprise: a data obtaining unit for capturing the design data from the designing device, and a measurement target setting unit for causing an operator to set a portion to be analyzed.

The present invention covers also a tolerance analyzing method and program in its scope.

With the system disclosed by the present invention, an optimum minimum gap with quality satisfactory for required quality (σ value) can be designed with ease.

Additionally, the amount of tolerance value examination time for implementing the optimum minimum gap can be significantly reduced, and at the same time, an operator can be prevented from redesigning and again manufacturing a product as a result of an incomplete examination.

### BRIEF DESCRIPTION OF THE DRAWINGS

FIGS. 1A and 1B explain a “sensitivity” used in this specification and claims;

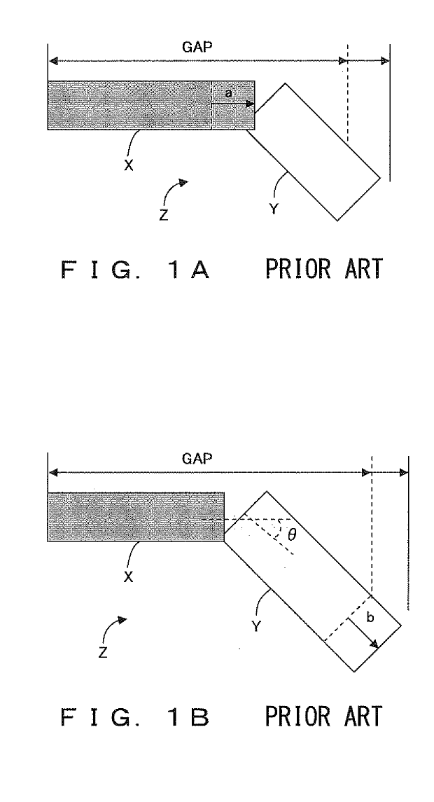

FIG. 2 is a flowchart showing an example of procedures for a tolerance analysis in a conventional tolerance analyzing/calculating system;

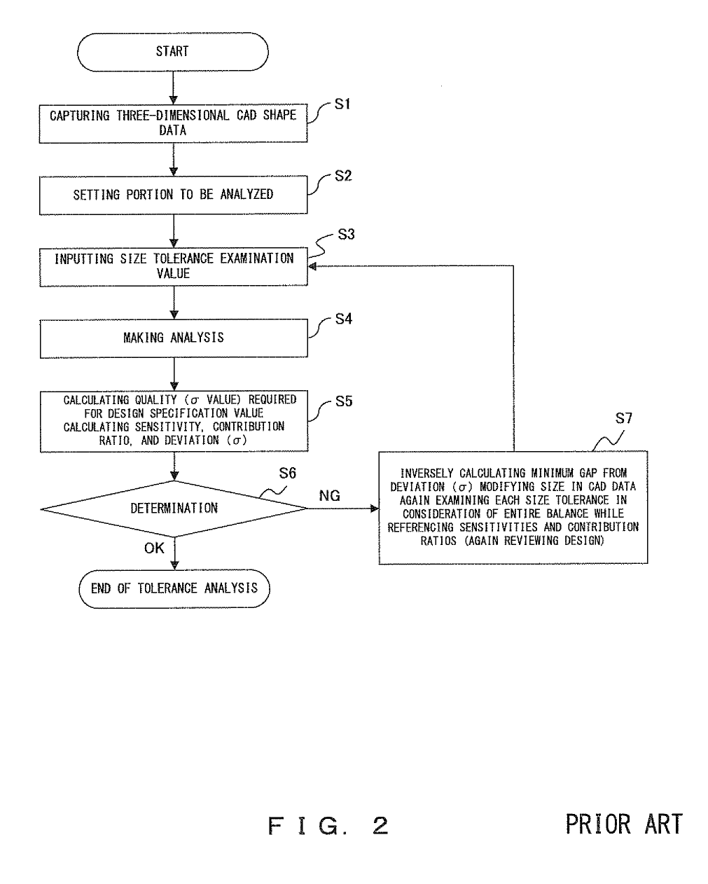

FIG. 3 shows an example of a configuration of a tolerance analyzing/calculating system according to a preferred embodiment;

FIG. 4 shows a structure for explaining the preferred embodiment;

FIG. 5 shows an example of capturing attribute information, which is made by a data obtaining unit;

FIG. 6 shows a GAP value of the structure in the preferred embodiment;

FIG. 7 shows an example of inversion calculation results of an optimum minimum gap value;

FIG. 8 shows results of a secondary analysis made by a secondary analysis executing unit;

FIG. 9 shows results of an analysis when the sizes of components are adjusted to implement an allowable maximum gap;

FIG. 10 shows the sensitivities and the contribution ratios of components A, B, and C;

FIG. 11 shows an example of a limit tolerance table;

FIG. 12 shows an example of results of an adjustment of a size tolerance;

FIGS. 13A and 13B show an example where design data and data of a size value and a size tolerance are linked, and fed back to a designing device;

FIG. 14 is a flowchart showing a tolerance analysis process executed by the tolerance analyzing/calculating system;

FIG. 15 shows a system environment when the tolerance analyzing/calculating system according to the preferred embodiment is implemented with an information processing device; and

FIG. 16 shows examples of storage media.

### DESCRIPTION OF THE PREFERRED EMBODIMENTS

A preferred embodiment according to the present invention is described below with reference to the drawings.

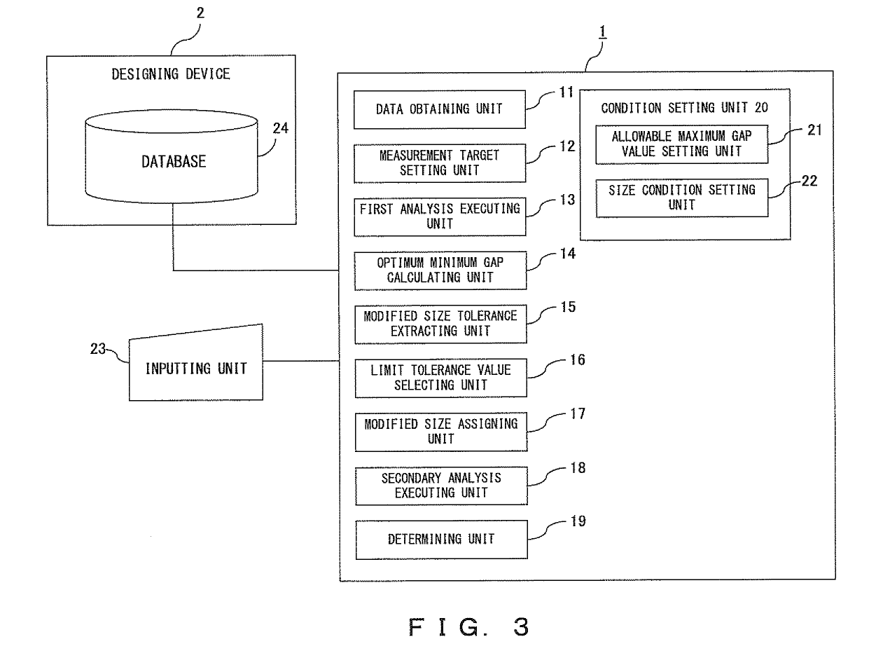

FIG. 3 shows an example of a configuration of a tolerance analyzing/calculating system according to the preferred embodiment.

The tolerance analyzing/calculating system 1 shown in this figure is connected to a designing device 2 such as a three-dimensional CAD, etc., and can receive design data such as three-dimensional CAD data, two-dimensional drawing data, etc. from a database of the designing device 2.

In this figure, the tolerance analyzing/calculating system 1 comprises a data obtaining unit 11, a measurement target setting unit 12, a primary analysis executing unit 13, an optimum minimum gap calculating unit 14, a modified size tolerance extracting unit 15, a limit tolerance value selecting unit 16, a modified size assigning unit 17, a secondary analysis executing unit 18, a determining unit 19, and a condition setting unit 20. Additionally, an inputting unit 23 is connected to this system.

The designing device 2 internally stores design data as the database 24.

The data obtaining unit 11 obtains size information, and material information stored as attribute values from the designing device 2. The measurement target setting unit 12 defines an examination target. The primary analysis executing unit 13 makes a rough primary analysis, and initially obtains a deviation. The optimum minimum gap calculating unit 14 calculates a minimum gap value within a range, which can secure target quality, from the deviation obtained with the analysis made by the primary analysis executing unit 13. The modified size tolerance extracting unit 15 extracts a component size to be modified when a tolerance must be modified to implement an optimum gap. The limit tolerance value selecting unit 16 selects a limit tolerance depending on a component or a shape. The modified size assigning unit 17 determines and assigns the degree of modification of a component in order to achieve a gap when not only a tolerance but also a size itself is modified. The secondary analysis executing unit 18 applies modified size and tolerance, and makes an analysis. This analysis is made for the final verification. The determining unit 19 determines obtained results.

The condition setting unit 20 is intended to input various types of setting conditions, and comprises an allowable maximum gap value setting unit 21, and a size condition setting unit 22.

The inputting unit 23 is a man-machine interface such as a pointing device, a keyboard, etc., with which an operator inputs an instruction to the tolerance analyzing/calculating system 1.

The allowable maximum gap value setting unit 21 sets a maximum gap value when a tolerance must be increased to secure target quality. The size condition setting unit 22 sets a condition of whether the size of each component that configures a structure is either unchangeable or changeable.

In the tolerance analyzing/calculating system 1 shown in FIG. 3, an optimum minimum gap value that satisfies required quality (σ value) is inversely calculated from a variance (σ2) or a deviation (σ) obtained from the results of the primary analysis when a tolerance is examined by utilizing design data such as three-dimensional CAD data, etc.

Additionally, the condition setting unit 20 for defining, as the attribute value information of each component, whether a size is either unchangeable or changeable, and an adjustment ratio in the case of a changeable size. The system determines a size value to be controlled in order to implement the optimum minimum gap obtained from the above results, the size value of each component is calculated to implement the optimum minimum gap, and a condition required to implement the desired optimum minimum gap can be obtained.

These operations are described in detail below by citing an example.

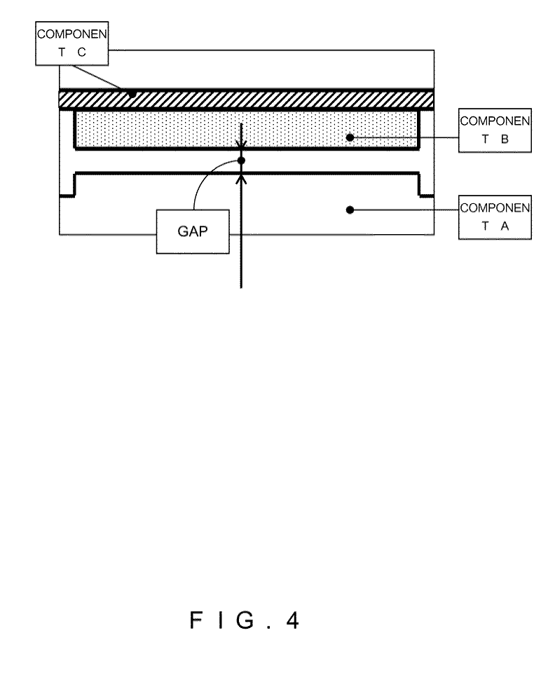

FIG. 4 shows a structure for an explanation.

The structure shown in this figure is composed of components A, B, and C. The case where a GAP between the components A and B is optimized is described below.

A tolerance analysis process by the tolerance analyzing/calculating system 1 is executed with the following procedures.

(1) Attribute information such as a material attribute, a sheet metal attribute, etc. of three-dimensional CAD data held by the designing device 2 is captured by the tolerance analyzing/calculating system 1. This capturing is made by the data obtaining unit 11. The attribute information may be defined by being stored in a memory in a way such that a conversion program is provided within the tolerance analyzing/calculating system 1, and serves as the data obtaining unit 11 when the tolerance analyzing/calculating system 1 is implemented with software.

The structure shown in FIG. 4 is assumed to have specifications such that a maximum GAP value allowable when the tolerances of components are accumulated is equal to or smaller than 0.5 mm, and its minimum value is equal to or larger than 0 mm. Here, assume that the specifications are desired to be minimized within a range that can guarantee the quality of 3σ.

(2) When an operator specifies as the attribute value information of each component whether a size is either unchangeable or changeable, and a ratio in the case of a changeable size with the inputting unit 23 in the tolerance analyzing/calculating system 1, these items of information are defined by the size condition setting unit 22 within the tolerance analyzing/calculating system 1.

Assume that the size of the component C is unchangeable, and those of the components A and B are changeable in this example. Additionally, the change ratios of the components A and B are defined to be 50 percent respectively.

(3) In the tolerance analyzing/calculating system 1, applicable limit tolerance information is held as a data table (limit tolerance table) that makes a correspondence between applicable limit tolerance information and a shape, a size, or a material. The tolerance analyzing/calculating system 1 compares the shape and the size of each component read from the design data, and the attribute information captured in (1) with the data table, whereby the tolerance analyzing/calculating system 1 determines the limit value of the size tolerance of each component.

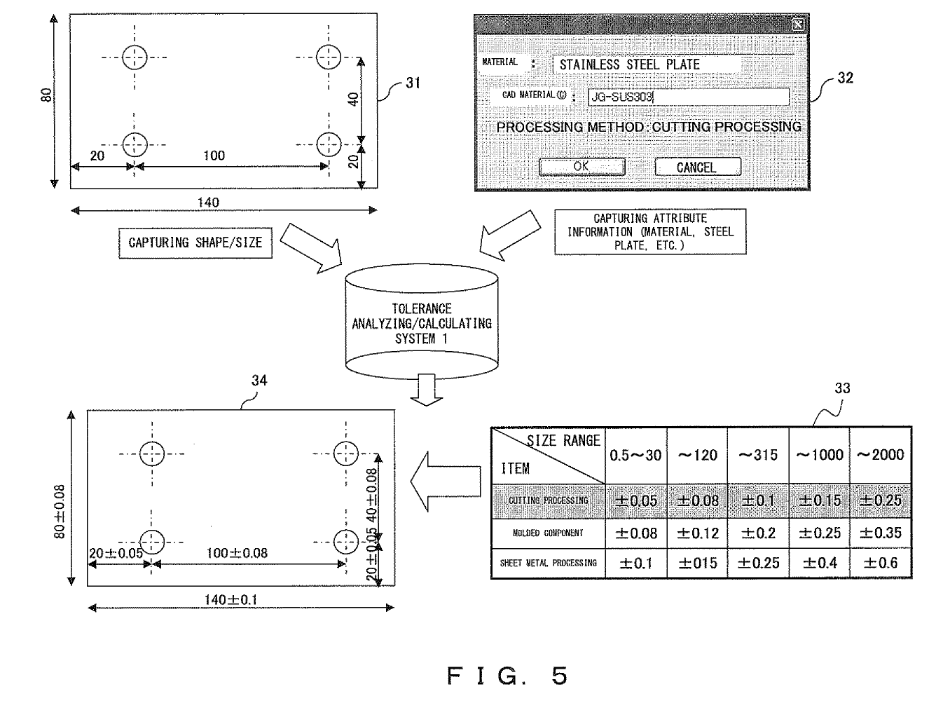

FIG. 5 shows an example of capturing attribute information, which is made by the data obtaining unit 11.

The tolerance analyzing/calculating system 1 captures information 31 about the shapes, the sizes, etc. of components from the designing device 2 as design information in the above described (1). Additionally, the tolerance analyzing/calculating system 1 captures the attribute information (material, sheet metal, etc.) 32 of each component from the designing device 2. Then, the tolerance analyzing/calculating system 1 obtains the limit value 34 of the size tolerance of each component by referencing the limit tolerance table 33 based on these items of information.

(4) The operator defines a portion to be analyzed by using the measurement target setting unit 12. Then, the operator sets required (aimed) quality (σ value) for a design specification value, and the maximum gap allowable in design as an allowable maximum gap value by using the allowable maximum gap value setting unit 21. The process for setting a measurement target is executed by the measurement target setting unit 12.

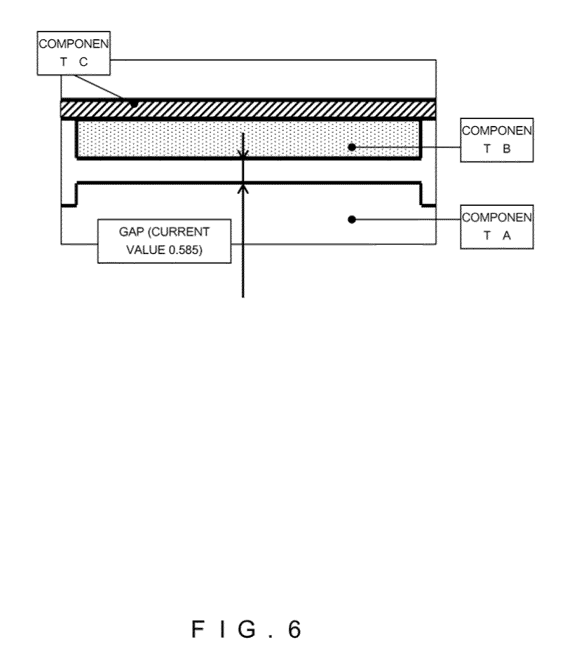

Assume that the current GAP value is 0.585 mm in the structure in this example as shown in FIG. 6. Since the allowable maximum GAP is 0.5 mm, it is minimized within a range that can guarantee the quality of 3σ.

(5) The operator defines the size tolerance of each component with the inputting unit 23 as designed and examined. Then, the primary analysis executing unit 13 makes a primary analysis for the gap to be optimized within the current gap value range from 0 to 0.585 mm, and calculates the sensitivity, the contribution ratio, the deviation (σ), and the current quality (the value of σ).

(6) The optimum minimum gap calculating unit 14 inversely calculates the optimum minimum gap value, which satisfies the required quality, from the deviation (σ) obtained with the primary analysis.

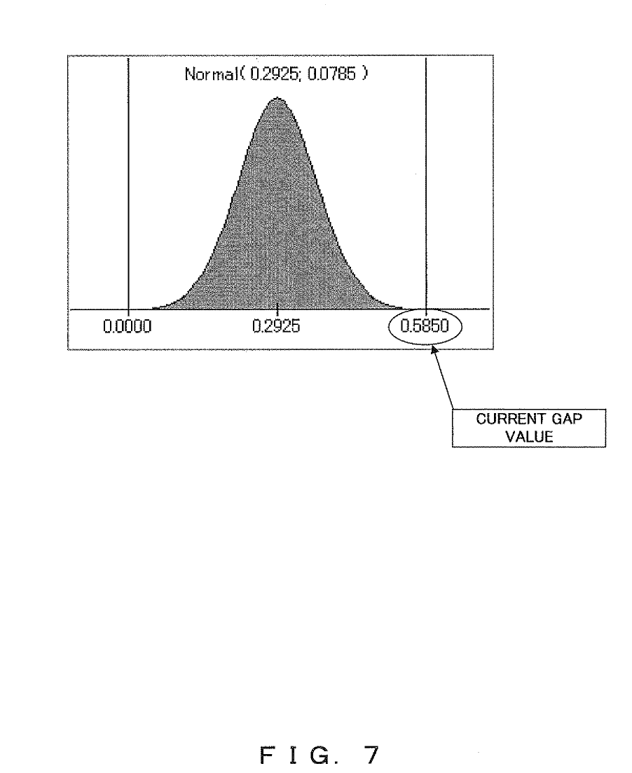

FIG. 7 shows an example of the results of the inverse calculation of the optimum minimum gap value.

In the example shown in this figure, the mean of the GAP value in a range from 0 to 0.585 mm is 0.2925, and the value of the deviation (σ) is 0.0785.

The optimum minimum gap value that satisfies 3σ is, on either of the sides of the components A and B,

0.0785×3=0.2355 (mm)

The odds are rounded up to 0.24 on either of the sides in consideration of a safety margin.

If this optimum minimum gap value is applied to both of the sides,

0.24×2=0.48 (mm)

The GAP results in 0.5 mm or smaller.

(7) The modified size assigning unit 17 of the tolerance analyzing/calculating system 1 assigns new sizes according to the ratio that is defined as a changeable size defined with the input of the operator in the above described (2) in order to implement the optimum minimum gap calculated in the tolerance analyzing/calculating system 1 in the above described (6).

In this example, the size of the component C is unchangeable, those of the components A and B are changeable, and the change ratio is 50 percent. Therefore, the new sizes are assigned as follows.

new size of component A=previous size of component A+(0.585−0.48)×0.5

new size of component B=previous size of component B+(0.585−0.48)×0.5

component C=left unchanged

Upon completion of the assignment, the secondary analysis executing unit 18 again makes an analysis, and the determining unit 10 determines the optimized state in the tolerance analyzing/calculating system 1.

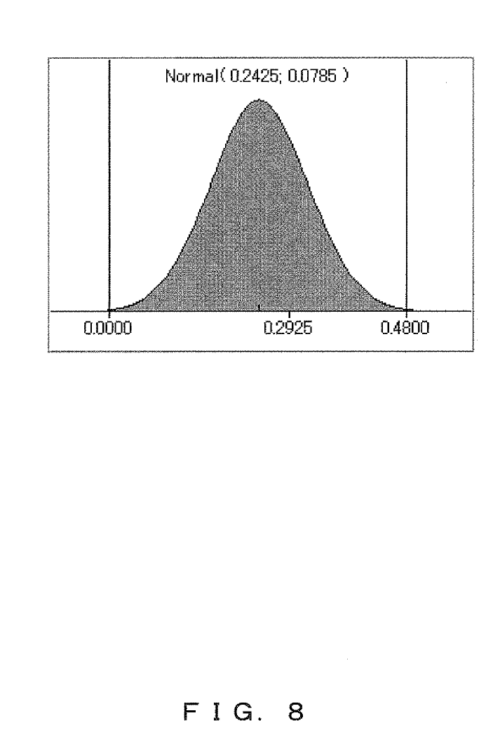

FIG. 8 shows results of the secondary analysis made by the secondary analysis executing unit 18.

In this figure, the gap value is obtained with the new size values obtained in (7). The gap value optimized with the new sizes falls within a range up to 0.4800, which is smaller than 0.5.

Accordingly, if the sizes of the components A and B are changed to the new sizes, the gap value can be optimized while satisfying the target quality of 3σ.

(8) If the optimum minimum gap calculated in (6) is significantly different from a desired value in design, or if the gap is desired to be further increased to improve a yield, etc., the modified size tolerance selecting unit 16 assigns new sizes according to the ratio defined with the changeable size input by the operator in (2) in order to implement the allowable maximum gap (0.5 mm) set by the operator in (4).

In this example, the size of the component C is unchangeable, those of the components A and B are changeable, and the ratio is 50 percent. Therefore, the new sizes are assigned as follows in order to implement the allowable maximum gap of 0.50 mm.

new size of component A=previous size of component A+(0.585−0.50)×0.5

new size of component B=previous size of component B+(0.585−0.50)×0.5

component C=left unchanged

Upon completion of the assignment, the modified size tolerance extracting unit 15 extracts a size tolerance that is adjustable and has a high effect produced by the adjustment within the optimum minimum gap value.

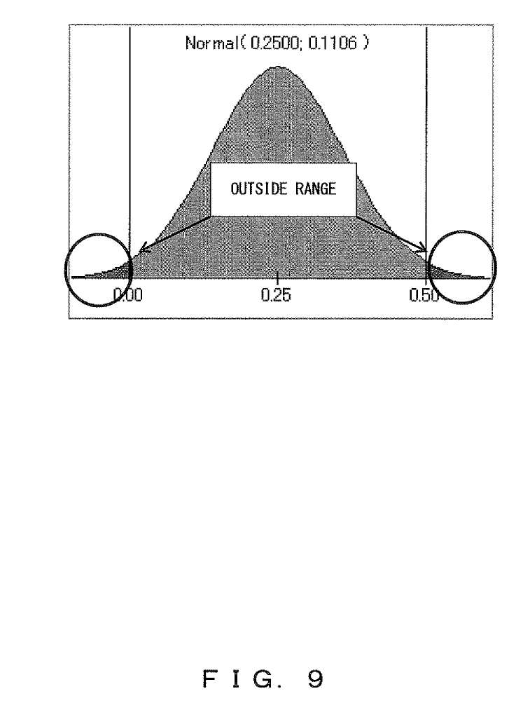

FIG. 9 shows analysis results when the sizes of the components are adjusted to implement the allowable maximum gap.

Considering the accumulated tolerances, the minimum gap value is desired to fall within a range from 0 to 0.5 mm with the target quality of 3σ as shown in this figure. In this case, however, the optimum minimum gap value cannot be made to fall within this range with the current tolerance.

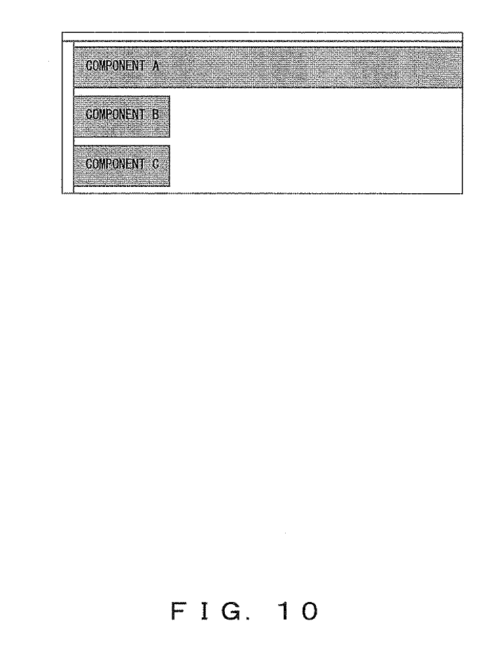

FIG. 10 shows the sensitivities and the contribution ratios of the components A, B, and C.

In this figure, as a numerical value increases, a size tolerance exerts more influence on a portion to be examined.

It is proved from this figure that the sensitivity and the contribution ratio of the component A are much higher than those of the components B and C, and the component A has a high effect if its size tolerance is adjusted.

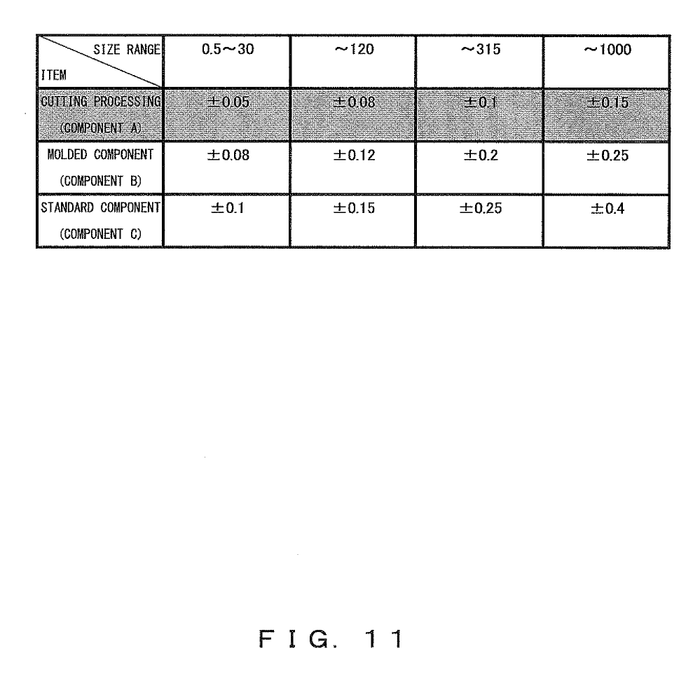

FIG. 11 shows an example of the limit tolerance table used in the determination made in (3).

The table shown in this figure represents the size tolerances of the components that configure the structure by size (size range).

It is proved from the limit tolerance table shown in this figure that, for example, the size tolerance of the component A is ±0.05 mm in a size range from 0.5 to 30 mm.

Here, assume that the components A, B, and C configuring the structure in this example have the sensitivities and the contribution ratios shown in FIG. 10, and correspond to the components within the limit tolerance table shown in FIG. 11.

In the tolerance analyzing/calculating system 1, the determining unit 10 determines based on the sensitivities and the contribution ratios that the effect produced by adjusting the size tolerance of the component A is high, and also determines based on the limit tolerance table that the size tolerance of the component A can be made most precise.

Accordingly, the modified size tolerance extracting unit 15 extracts the size tolerance of the component A as a size tolerance to be adjusted.

(9) For the size tolerance extracted in (8), the secondary analysis executing unit 18 calculates the optimum minimum gap when the precision is increased to the limit in terms of tolerance by using the limit value of the size tolerance that the determining unit 19 determines from the limit tolerance table.

Assume that the thickness sizes of the components A, B, and C are 3, 2, and 1 mm respectively in this example.

In this case, the secondary analysis executing unit 18 selects the limit value ±0.05 mm of the size tolerance in the size range from 0.5 to 30 mm of the component A from the limit tolerance table shown in FIG. 11, and substitutes the selected value, so that the optimum minimum gap is calculated.

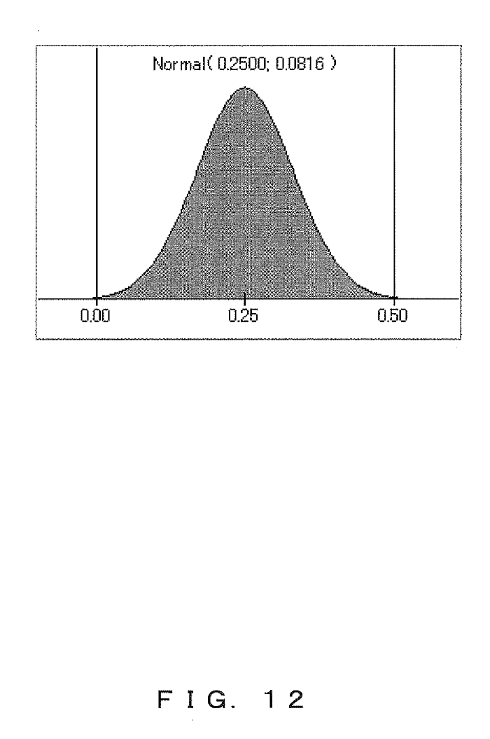

FIG. 12 shows an example of results of the adjustment of a size tolerance.

It is proved from this figure that the minimum gap can be made to fall within the range from 0 to 0.5 mm while securing the equality of 3σ because the size tolerance is adjusted as described above. In the tolerance analyzing/calculating system 1, the determining unit determines whether or not such a condition is satisfied.

(10) A mechanism for causing the tolerance analyzing/calculating system 1 to feed the data of the size values and the size tolerance values, which are obtained with the above described processes (5) to (9), back to feature information (parameters of a shape, a size value, etc.) of the design data within the designing device 2, which is connected to the tolerance analyzing/calculating system 1 and into which design data is to be read, is provided, and the designing device 2 reproduces the fed back information, and reflects the reproduced information on shape data.

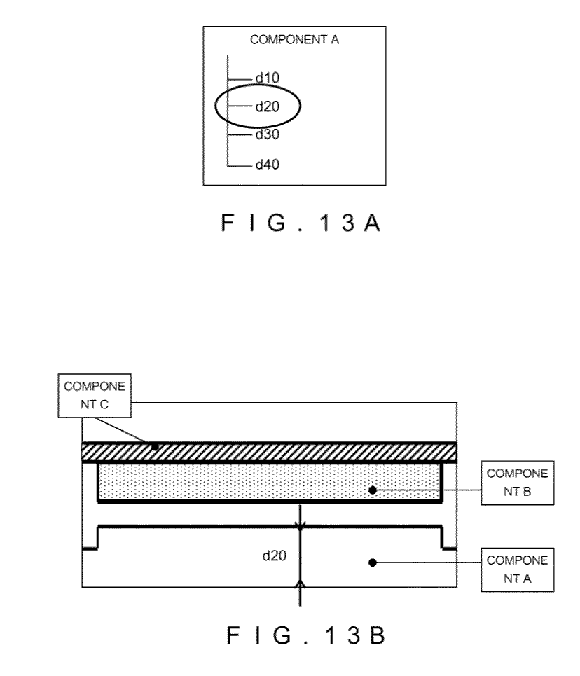

FIG. 13 shows an example where the design data, and the data of the size values and the size tolerance values are linked and fed back to the designing device 2 as described in (10).

In the tolerance analyzing/calculating system 1, sizes are respectively managed with size IDs. On the display screen of the designing device 2, the size information of the component A, which is captured in the tolerance analyzing/calculating system 1, is displayed as a listing with size IDs as shown in FIG. 13A.

Assume that the thickness size of the component A is defined with a size ID d20.

Each piece of size information of the structure, the design data of which is captured by the tolerance analyzing/calculating system 1, is linked to the design data of the designing device 2 with information IDs.

If the operator selects the thickness size ID (d20) of the component A on the display screen of the designing device 2, which is shown in FIG. 13A, the designing device 2 obtains size information corresponding to the size ID (d20) from the tolerance analyzing/calculating system 1. Then, the position of the thickness of the component A, which corresponds to the size ID (d20), is displayed on the display screen of the designing device 2 as shown in FIG. 13B.

Then, the designing device 2 displays a shape on which the new information is reflected based on the newly captured size information.

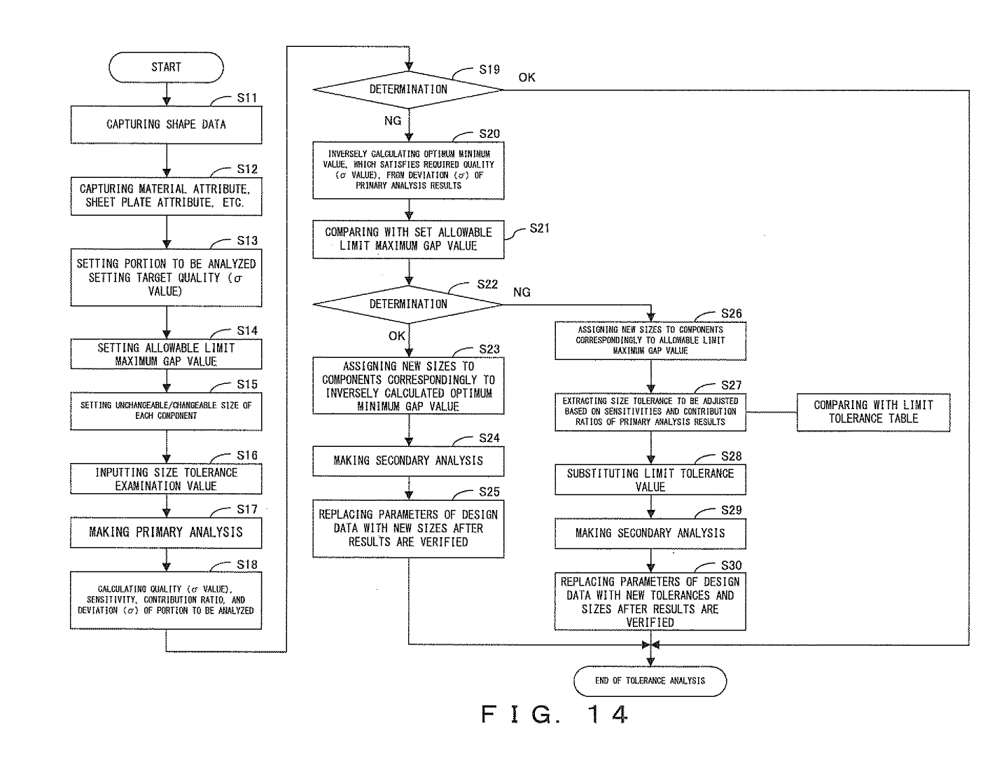

FIG. 14 is a flowchart showing a tolerance analysis process executed by the tolerance analyzing/calculating system 1.

Once the process shown in this figure is started, shape data is captured as design data from the designing device 2 in step S11. Then, in step S12, the tolerance analyzing/calculating system 1 captures attribute information such as a material attribute, a sheet metal attribute, etc. as design data from the designing device 2.

Then, in step S13, the tolerance analyzing/calculating system 1 prompts an operator to input a portion to be analyzed and target quality (σ value). When the operator inputs the portion to be analyzed and the target quality (σ value) with the inputting unit 23, these items of information are set in the tolerance analyzing/calculating system 1.

Next, in step S14, the tolerance analyzing/calculating system 1 prompts the operator to input an allowable limit maximum gap value. When the operator inputs the allowable limit maximum gap value with the inputting unit 23, this information is set in the tolerance analyzing/calculating system 1.

In step S15, the tolerance analyzing/calculating system 1 also prompts the operator to input whether the size of each component is either unchangeable or changeable, and the ratio in the case of a changeable size. When the operator inputs these items of information, they are set by the size condition setting unit 22 in the tolerance analyzing/calculating system 1.

Next, in step S16, the tolerance analyzing/calculating system 1 causes the operator to input a size tolerance examination value.

Then, in step S17, the primary analysis executing unit 13 makes a primary analysis based on the size tolerance examination value input in step S16.

As a result of the primary analysis, the quality value (σ value), the sensitivity, the contribution ratio, and the deviation (σ) of the portion to be analyzed are calculated in step S18.

Based on the results of the primary analysis, whether or not the deviation (σ) calculated in step S18 reaches the required quality is determined. If the deviation reaches the required quality (“OK” in step S19), this means that the size tolerance input in step S16 satisfies the required quality. Therefore, this tolerance analysis process is terminated.

If the determining unit 19 determines that the deviation (σ) obtained with the primary analysis does not satisfy the required quality (“NG” in step S19), the optimum minimum gap value that satisfies the required quality (σ value) is inversely calculated from the deviation (σ) that is calculated from the results of the primary analysis in step S20.

Then, in step S21, the optimum minimum gap value obtained in step S20 is compared with the allowable limit maximum gap value set in step S14. If the optimum minimum gap value obtained in step S20 is smaller than the allowable limit maximum gap value (“OK” in step S22), new sizes are respectively assigned to the components correspondingly to the optimum minimum gap value inversely calculated in step S20.

Then, in step S24, the secondary analysis executing unit 18 makes a secondary analysis by using the new sizes assigned in step S23.

Lastly, in step S25, the system causes the operator to verify the results of the secondary analysis, replaces the parameters of the design data with the new sizes, and terminates the tolerance analysis process.

If the optimum minimum gap value obtained in step S20 is larger than the allowable limit maximum gap value in the determination of step S22 (“NG” in step S22), new sizes are assigned to the components correspondingly to the allowable limit maximum gap value in step S26.

Then, the modified size tolerance extracting unit 15 extracts a size tolerance to be adjusted by referencing the limit tolerance table based on the sensitivities and the contribution ratios, which are obtained with the primary analysis, in step S27.

Next, the system causes the operator to substitute a limit tolerance value in step S28. Then, the secondary analysis is made with this value in step S29.

In step S30, the system causes the operator to verify the results of the secondary analysis. Then, the parameters of the design data are replaced with the new tolerances and the new sizes. Here, the tolerance analysis process is terminated.

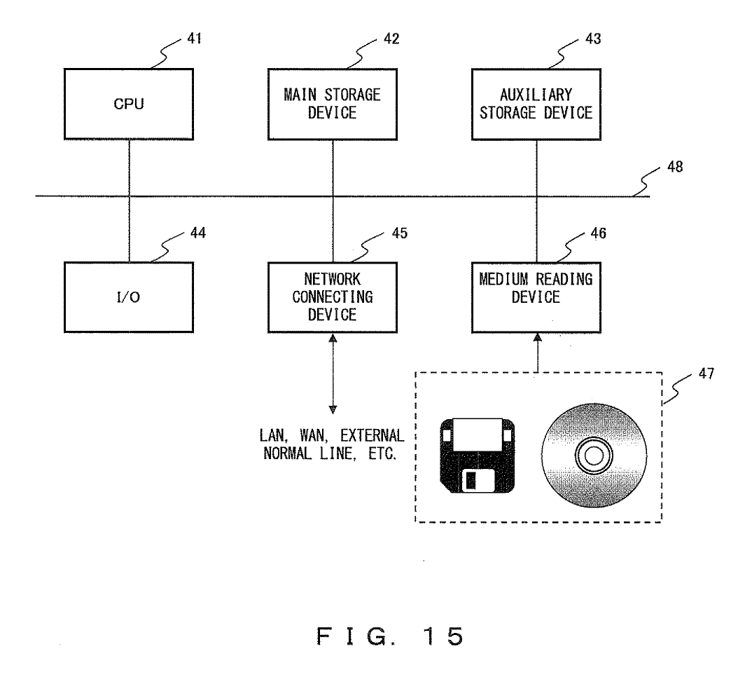

FIG. 15 shows a system environment when the tolerance analyzing/calculating system 1 according to this preferred embodiment is implemented with an information processing device such as a PC, etc.

The information processing device shown in FIG. 15 comprises a CPU 41, a main storage device 42 such as a RAM, etc., an auxiliary storage device 43 such as a hard disk, etc., input/output devices (I/O) 44 such as a display, a keyboard, a pointing device, etc., a network connecting device 45 such as a modem, etc., and a medium reading device 46 for reading contents stored on a portable storage medium such as a disk, a magnetic tape, etc. These constituent elements are interconnected by a bus 48, and mutually transmit/receive data via the bus 48.

The CPU 41 implements the functions of the constituent elements of the tolerance analyzing/calculating system 1, which are shown in FIG. 3, and the process of the flowchart shown in FIG. 14 by executing a program stored in the auxiliary storage device 43, or a program installed via the network connecting device 45 with the use of the main storage device 42 as a working memory.

In the information processing device shown in FIG. 15, a program and data, which are stored on the storage medium 47 such as a magnetic tape, a flexible disk, a CD-ROM, an MO, etc., are read by the medium reading device 46, and loaded into a portable terminal according to the preferred embodiment via an external interface 45. Then, the program and the data are executed and used by the portable terminal, whereby the above described process of the flowchart is implemented in a software fashion.

Additionally, in the information processing device shown in FIG. 15, application software is sometimes replaced by using the storage medium 47 such as a CD-ROM, etc. Accordingly, the present invention is not limited to the tolerance analyzing/calculating system, the tolerance analyzing method and the program, and can be also configured as a computer-readable storage medium 47 for causing a computer to execute the above described functions according to the preferred embodiment of the present invention when used by the computer.

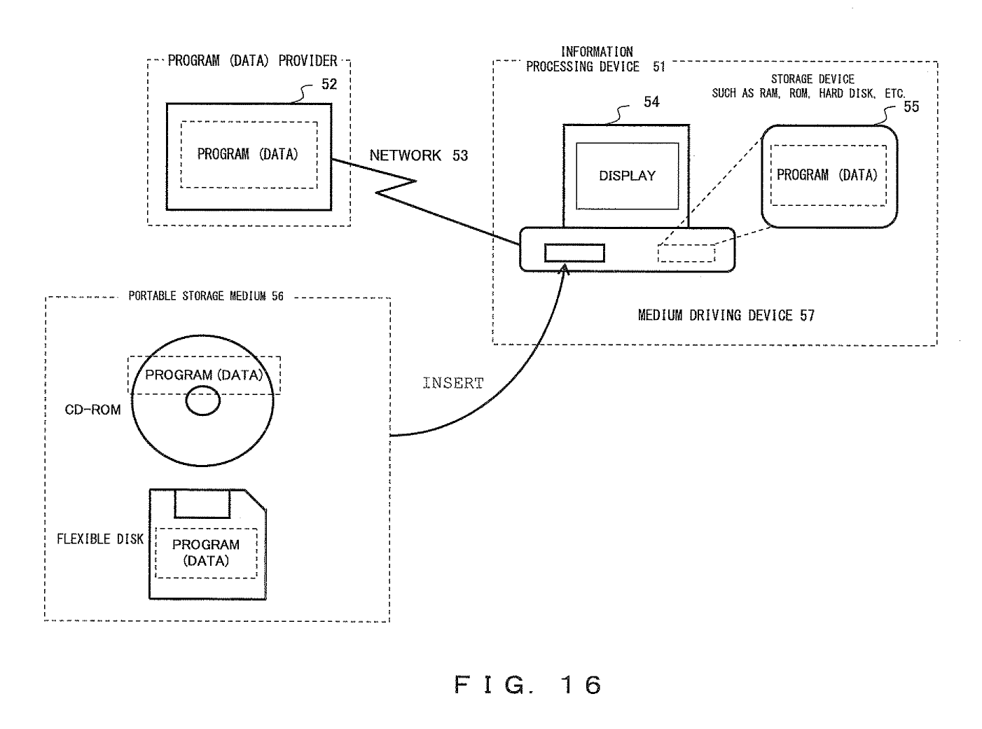

In this case, examples of the storage medium include a portable storage medium 56 such as a CD-ROM, a flexible disk (or an MO, a DVD, a memory card, a removable hard disk, etc.), which is insertable/ejectable into/from a medium driving device 57, a storing unit (a database, etc.) 52 within an external device (a server, etc.), the contents of which are transmitted via a network line 53, and a memory (a RAM, a hard disk, etc.) 55 within a main body 54 of an information processing device 51 as shown in FIG. 16. A program stored on the portable storage medium 56 or in the storing unit (the database, etc.) 52 is loaded into the memory (the RAM, the hard disk, etc.) 55 within the main body 54, and executed.

The present invention can be also carried out by using not only the above cited storage media but also various types of future large-capacity storage media, which include a next-generation optical disk storage medium using a blue laser such as Blu-ray Disk (registered trademark), AOD (Advanced Optical Disc), etc., an HD-DVD 9 using a red laser, and Blue Laser DVD using a blue-violet laser, as the above described storage medium such as a CD-ROM, a DVD-ROM, etc.

What is claimed is:

1. A tolerance analyzing/calculating system for analyzing and examining a size tolerance of each component configuring a structure with respect to a size tolerance at the time of assembly of the structure designed with design data, comprising:
a size condition setting unit defining design data, and a size tolerance of each component;
a primary analysis executing unit obtaining a variance or a deviation by making a primary analysis with the use of the size tolerance defined by said size tolerance setting unit; and
an optimum minimum gap calculating unit calculating an optimum minimum gap value by inversely calculating a gap value, which satisfies required quality for a design specification value, with the use of the variance or the deviation, which is obtained by said primary analysis executing unit.

2. The tolerance analyzing/calculating system according to claim 1, further comprising:
a modified size assigning unit calculating a size value of each component in order to implement the optimum minimum gap value obtained from results of the primary analysis, wherein:
said size condition setting unit defines whether a size is either unchangeable or changeable, and a ratio in a case of a changeable size as attribute value information of the each component; and
said modified size assigning unit determines a size value to be controlled in order to implement the optimum minimum gap value based on the attribute information.

3. The tolerance analyzing/calculating system according to claim 1, further comprising:
an allowable maximum gap value setting unit setting an allowable maximum gap value that is a maximum gap allowable in design; and
a modified size tolerance extracting unit adjusting the size tolerance of each component if the optimum minimum gap value calculated by said optimum minimum gap calculating unit is larger than the allowable maximum gap value.

4. The tolerance analyzing/calculating system according to claim 1, further comprising:
an allowable maximum gap value setting unit setting an allowable maximum gap value that is a maximum gap allowable in design; and
a modified size assigning unit assigning a new size of each component, which corresponds to the optimum minimum gap, if the optimum minimum gap value calculated by said optimum minimum gap calculating unit is smaller than the allowable maximum gap value.

5. The tolerance analyzing/calculating system according to claim 1, further comprising:
a data obtaining unit capturing attribute information including a material attribute or sheet plate information within the design data;
a limit tolerance table that makes a correspondence between applicable limit tolerance information and a shape, a size, or a material;
a first determining unit determining a limit value of the size tolerance of each component by comparing a limit tolerance table and the shape, the size, and the attribute information, which are read from the design data; and
a modified size tolerance extracting unit extracting a size tolerance value that is adjustable and has a high effect produced by an adjustment within the optimum minimum gap value based on the limit value of the size tolerance, sensitivities and contribution ratios, which are obtained from results of the primary analysis.

6. The tolerance analyzing/calculating system according to claim 5, further comprising:
a secondary analysis executing unit making a secondary analysis for calculating an optimum minimum gap value when precision is increased to a limit in terms of tolerance from a limit value of the size tolerance determined by said first determining unit for the size tolerance value extracted by said modified size tolerance extracting unit.

7. The tolerance analyzing/calculating system according to claim 6, further comprising:
a second determining unit obtaining an optimum size and size tolerance of the each component from results of the secondary analysis.

8. The tolerance analyzing/calculating system according to claim 7 being connected to a designing device holding the design data, the system linking the size value and the size tolerance value of each component to the design data within the designing device, and feeding the optimum size and size tolerance back to the designing device, and the designing device reproducing the fed back information and reflecting the reproduced information on shape data.

9. The tolerance analyzing/calculating system according to claim 1, further comprising:
a data obtaining unit capturing the design data from the designing device; and
a measurement target setting unit causing an operator to set a portion to be analyzed.

10. A tolerance analyzing method for analyzing and examining a size tolerance of each component configuring a structure with respect to a size tolerance at the time of assembly of the structure designed with design data, comprising:
defining design data, and a size tolerance of each component;
obtaining a variance or a deviation by making a primary analysis with the use of the defined size tolerance; and
calculating an optimum minimum gap value by inversely calculating a gap value, which satisfies required quality for a design specification value, with the use of the variance or the deviation, which is obtained from results of the primary analysis.

11. A computer-readable storage medium, which can be read by an information processing device, and on which is stored a program for causing the information processing device, which analyzes and examines a size tolerance of each component configuring a structure with respect to a size tolerance at the time of assembly of the structure designed with design data, to execute a process, the process comprising:
loading design data, and a size tolerance of each component into a memory, and defining the design data and the size tolerance;
obtaining a variance or a deviation by making a primary analysis with the use of the defined size tolerance; and
calculating an optimum minimum gap value by inversely calculating a gap value, which satisfies required quality for a design specification value, with the use of the variance or the deviation, which is obtained from results of the primary analysis.
